(19) United States
(12) Patent Application Publication
(10) Pub. No.: US 2011/0042146 A1
(43) Pub. Date: Feb. 24, 2011

(54) Drill Bit Head for Percussion Drilling Apparatus

(76) Inventors: Frank Friedrich Lachmann, Burghaun (DE); Gerald F. Flynn, Burghaun (DE); Karl Georg Hildebrand, Burghaun (DE)

Correspondence Address: FROMMER LAWRENCE & HAUG, 745 FIFTH AVENUE- 10TH FL., NEW YORK, NY, 10151, US

(21) Appl. No.: 12/919,803

(22) PCT Filed: May 11, 2009
(86) PCT No.: PCT/IB2009/051928

§ 371 Date: Oct. 18, 2010

(30) Foreign Application Priority Data
May 9, 2008 (GB) 0808366.9

(51) Int. Cl. E21B 10/36; B22F 7/00; B05D 1/08; B23K 1/00

(52) U.S. Cl. 175/414; 419/5; 427/446; 228/101

(57) ABSTRACT

This invention relates to a percussion drill bit head for a percussion drilling apparatus, the drill bit head comprising a working surface and a plurality of super-hard buttons protruding from the working surface, the working surface having a hard area that is free of buttons and has Rockwell C hardness of at least 60 HRc. The invention further relates to a method of manufacturing a percussion drill bit head comprising a working surface and a plurality of buttons and a percussion drill bit assembly comprising a drill bit head according to the invention.

### INTRODUCTION

This invention relates to percussion drilling bits and bit assemblies, particularly drill bit heads for percussion drilling apparatus, as may be used in earth boring applications in the mining and construction industries.

### BACKGROUND

Boring into the earth is an important activity in many industries, such as mining, oil and gas drilling, prospecting and tunnel construction. A wide variety of methods and various different types of bits are available for this purpose. There are three contrasting approaches that are commonly used for boring into the earth in the oil and gas drilling, mining and construction industries, namely rotary shear drilling, roller cone drilling and percussion drilling.

In rotary shear drilling, a rotating drill bit head comprising a plurality of blades or cutter inserts bores into rock by a shearing action. In roller cone drilling, the drill bit comprises several (typically three) “roller cones”, each comprising a plurality of buttons or cutter inserts. As the drill bit rotates, each of the roller cones is caused rotate on its own axis, the blades or cutter inserts fracture the rock by pressing onto it with a high pressure. In percussion drilling, a drill bit comprising a plurality of buttons or cutter inserts repeatedly impacts, or hammers, a body rock at high frequency. Typically, the bit head is caused to rotate slightly between successive impacts in order to degrade the rock as much as possible. This gave rise to the term “rotary percussive drilling”, although the “rotary” aspect is quite distinct from that in true rotary drilling, wherein the rotary aspect is essential for shearing the rock. Percussion drilling is widely used in mining and construction, to drill bore holes and blast holes, for example.

In percussive drilling, the bit head and body tends to be much less vulnerable to abrasive wear that those in rotary or roller cone drilling, since in the latter cases the bit head and associated components rotate rapidly against abrasive rock. For this reason, the bit heads and bodies of percussion drill bits are typically made of steel, which has adequate abrasion resistance and is cost effective.

GB patent number 995599 discloses a rotary-percussion bit having a cylindrical or slightly conical wall a base generally transverse to the axis of the drill, and blunt cutting inserts in the base, the row of the inserts being inclined relative to the axis.

U.S. Pat. No. 3,952,819 discloses a fatigue resistant anvil bit for a percussion rock drill, comprising an elongated anvil body having a rear impact end with an anvil head section and having an integrally formed shank extending from the rear end to a threaded bit end; an enlarged removable bit head threadably mounted on the threaded bit end with a plurality of cutting elements mounted in a face surface thereof; said enlarged bit head having a rear surface extending laterally from the shank.

GB patent number 1250146 discloses a bit assembly for a bottom hole impact drilling tool, comprising a bottom anvil, a cylindrically-shaped bit removably mounted on the anvil coaxially with a center line, said bit having a back surface and a plurality of tapered bores formed in the face surface for receiving and holding button assemblies. The bit has a plurality of access apertures formed in the back surface, aligned and communicating with the tapered bores for enabling the tapered button assemblies to be pushed from the bores when the bit is removed from the anvil to replace buttons when they become excessively worn.

U.S. Pat. No. 4,694,918 discloses a percussion rock bit, comprising a steel body; means at one end of the steel body for connecting the bit to a drill string a plurality of inserts embedded in the other end of the steel body, at least a portion of the inserts comprising a cemented tungsten carbide body having a grip portion embedded in the steel body and a converging end portion protruding from the surface of the steel body a polycrystalline diamond layer on the converging end of the carbide body; at least one transition layer between the polycrystalline diamond layer and the carbide body, such a transition layer comprising a composite containing diamond crystals and pre-cemented tungsten carbide particles, where the diamond crystal content is greater adjacent the polycrystalline diamond layer and lower adjacent the cemented tungsten carbide body.

Japan patent publication number 07-197760 discloses a percussive bit, the whole of head of which is made of cemented carbide and a button-like body is integrated with the plane of the tip so as to project therefrom. Since this bit is made from cemented carbide, the whole head has excellent abrasion resistance.

There is a need for a percussion drill bit having working life substantially longer than known percussion bits having super-hard inserts.

### SUMMARY OF THE INVENTION

According to a first aspect of the invention there is provided a percussion drill bit head for a percussion drilling apparatus, the drill bit head comprising a working surface and a plurality of super-hard buttons protruding from the working surface, the working surface having a hard area that is free of buttons and which hard area has a Rockwell C hardness of at least 60 HRc.

A working surface is any part of the drill bit head which may, in use, contact a workpiece or body being worked, for example, rock. It is understood that any portion of a working surface is also a working surface.

The term “super-hard” used in relation to a material is understood to mean that the material has a hardness of at least 30 GPa. Diamond and cubic boron nitride (cBN) are examples of super-hard material.

A button is understood to mean a protrusion from the surface of a body, typically but not necessarily being an insert element embedded into a recess within the body. Alternatively, a button may be integrally formed with the body or otherwise affixed to it. Typically, a button is a cutting or gouging element intended to degrade, cut, break or bore into a workpiece or rock by impact or shearing.

Preferably at least 50% of the buttons included on the drill bit head comprise a super-hard material, more preferably at least 90% of the buttons comprise super-hard material.

Preferably the super-hard material comprises diamond.

Preferably the hard area has Rockwell C hardness greater than 65 HRc, more preferably 70 HRc. The hard area may comprise a hard-metal, and preferably the region comprises a super-hard material.

Preferably at least 10% of the volume of the drill bit head consists of hard material having Rockwell C hardness greater than 60 HRc, and more preferably at least 50% of the volume of the drill bit head consists of hard material having Rockwell C hardness greater than 60 HRc. Yet more preferably the hard material is a hard-metal.

For the avoidance of doubt, a hard material is a material having Rockwell C hardness greater than 60 HRc,

A “hard-metal” is understood herein to mean a hard material comprising grains of metal carbide, especially tungsten carbide (WC) or less typically titanium carbide (TIC) or other carbides, dispersed within a binder phase comprising a metal, especially cobalt (Co) or less typically nickel (Ni) or metal alloy. The binder phase may be said to cement the grains together as a sintered compact, typically having negligible porosity. The most common hard-metal is Co-cemented WC.

Preferably the drill bit head comprises a hard volume coterminous with the hard area, the hard volume extending from the working surface to a depth, the hard volume consisting of hard material having Rockwell C hardness greater than 60 HRc. Preferably the depth is at least 0.5 millimetres, more preferably the depth is at least 1 millimetre, and yet more preferably the depth is at least 5 millimetres. Preferably the hard material has Rockwell C hardness greater than 70 HRc, more preferably the hard material is a hard-metal, most preferably the hard material comprises tungsten carbide.

The hard volume may be in the form of a layer bonded or otherwise affixed to a steel body (substrate).

Preferably the hard area covers at least 20% of the maximum working surface, more preferably the hard area covers at least 50% of the maximum working surface, most preferably the hard area covers at least 70% of the maximum working surface of the drill bit head.

Preferably the drill bit head comprises a hard layer bonded to or formed onto a steel substrate, the layer having a thickness and comprising hard material having Rockwell C hardness greater than 60 HRc. Preferably the thickness is at least 0.5 millimetres, more preferably the thickness is at least 1 millimetre, and most preferably the thickness is at least 5 millimetres. Preferably the hard material has Rockwell C hardness greater than 70 HRc, more preferably the hard material is a hard-metal, and most preferably the hard material comprises tungsten carbide.

The hard volume is may be applied to the drill bit head by means of a spraying method, such as thermal spraying, or a welding or fusing method, or other hard-facing method.

Preferably the buttons are inserts comprising diamond, preferably polycrystalline diamond. The percussion drill bit head is preferably removably attachable to a percussion anvil assembly by mechanical (e.g. threading, press-fit, shrink-fit, knock-on), chemical and/or metallurgical methods, such as brazing. Preferably the drill bit head is attachable by mechanical methods, such as a screw thread, and is capable of being detached without causing substantial damage to either the percussion anvil assembly or the bit head. A combination of attachment methods may be used (e.g. mechanical combined with brazing).

The percussion drill bit head may comprise an end facing surface which, in use, is positioned opposed a work piece or body being worked. The end facing surface of the drill bit head or a substantial portion thereof may have a substantially planar form, or have a convexly domed form or even a convex form.

According to a second aspect of the present invention there is provided a method of manufacturing a percussion drill bit head according to the invention comprising a working surface and a plurality of buttons, the method including subjecting the percussion drill bit head or portion thereof, the portion including a region of a working surface that is free of buttons, or a precursor article thereof to a pressure of at least 20 MPa and a temperature of at least 900 degrees centigrade.

Preferably the drill bit head is manufactured by a method including subjecting a green body to a sintering step wherein the pressure is at least 20 MPa and a temperature of at least 900 degrees centigrade. Preferably the temperature is at least 1,200 degrees centigrade.

A green body is a term known in the art of hard-metal manufacture and refers to an article intended to be sintered, but which has not yet been sintered. It is generally self-supporting and has the general form of the intended finished article.

Preferably the drill bit head comprises hard-metal and the green body has the general form of the drill bit head, the drill bit head being produced by sintering a green body by means of a conventional hard-metal sintering method.

Preferably the drill bit head is manufactured by a method including subjecting a green body to a sintering step wherein the pressure is at least 20 MPa and a temperature of at least 900 degrees centigrade to form a sintered bit body; and affixing a plurality of buttons to the sintered bit body.

Preferably the temperature is at least 1,200 degrees centigrade.

Preferably the buttons are inserts comprising polycrystalline diamond integrally bonded to a hard-metal support substrate.

Preferably the green body and sintered bit body are formed with recesses adapted to accommodate and hold the inserts (buttons).

A super-hard material may be sintered and attached to the drill bit head, or a portion thereof, in a single step carried out under conditions at which the super-hard material is thermodynamically stable. In this way, the super-hard material is formed integrally with the bit head and is not attached to it as part of an insert.

The conditions at which the super-hard material is thermodynamically stable include a pressure of at least about 1 Gpa, and preferably at least about 2 Gpa.

According to a third aspect of the invention there is provided a method for making a hard-faced percussion drill bit head according to the invention, the method including forming a drill bit head or portion thereof and depositing a layer of hard material onto a working surface of the drill bit head or portion thereof, the layer of hard material having Rockwell C hardness greater than 60 HRc, more preferably greater than 70 HRc. Preferably the hard material comprises a hard-metal, more preferably the hard-metal, comprises cemented tungsten carbide.

Preferably the layer of hard material is deposited by means of thermal spraying, as is known in the art, or by a welding method, or by a brazing method.

According to a fourth aspect of the invention there is provided a percussion drill bit assembly comprising a percussion drill bit head according to the invention or manufactured by a method according to the invention.

A percussion drill bit head according to the invention will typically cost substantially more to manufacture than known percussion drill bit heads for percussion drills bits, since harder materials and additional manufacturing process steps are called for. On the other hand, it has been found that conventional percussion drill bit heads having buttons comprising a material having hardness much greater than that of steel, which is conventionally used to make drill bit heads, are generally not economical. This is because the working surface of the drill bit head wears away long before the potentially long working life of the buttons is reached. This has particularly limited the commercial viability of percussion drill bit heads mounted with PCD inserts. While PCD is an extremely abrasion resistant material, the working like of known percussion bits bearing PCD inserts is limited by the wear rate of the bit head working surfaces, which wear away rapidly relative to the wear rate of the PCD. So, while the cost of manufacturing the percussion drill bit heads according to the invention may be substantially higher than that of conventional bit heads, the percussion drill bit heads of the invention are commercially more viable in the final analysis, since the drill bit heads have substantially longer working life than known percussion drill bit heads having PCD inserts. A long-felt need to exploit viably the potential of PCD and other super-hard materials in percussion drilling is therefore addressed by the invention.

### Example

A percussion drill bit head as illustrated in FIG. 4 is exemplified.

PCD buttons are shrink-fit into a solid tungsten carbide percussion drill bit head. Each PCD button is OD-ground (i.e. the outer diameter must be ground) to a diameter 0.02 mm less than that of the corresponding recess in the bit head. The surface roughness is in the range from 0.6 to 0.8 micrometers. The walls of the recess have a surface roughness in the same range. To fit the PCD buttons, the drill bit head is heated to 450 degrees centrigrade.

The drill bit head is shrink-fit onto a steel shaft. The steel should be hardened to a hardness of 46-50 HRC. The preferred steel is SKF 388 (registered trade mark). The shrinkage fit of the steel part is ground and measured to a tolerance of 0.2-0.25% in diameter. The steel part is heated to a temperature of 450 degrees centigrade, at which temperature the parts are connected.

### FIGURES

Preferred non-limiting embodiments will now be described with reference to the accompanying drawings, of which:

FIGS. 1 and 2 show schematic diagrams of longitudinal cross-sections of embodiments of assemblies comprising percussion drill bit heads and ends of anvil portions of drill bits;

FIG. 3 shows a schematic diagram of a longitudinal cross-section of an embodiment of a shaped insert for a drill bit head;

FIGS. 4 to 14 show:
(a) schematic drawings of side perspective views of different embodiments of percussion drill bit heads mounted onto anvil portions of percussion bits as in use;
(b) schematic drawings of axial cross section views of corresponding embodiments, the cross sectional plane being along A-A of the corresponding figure (e);
(c) schematic drawings of axial cross section views of corresponding embodiments, the cross sectional plane being along C-C of the corresponding figure (e);
(d) a perspective exploded view of corresponding figure (a);
(e) a top view of corresponding figure (a); and
(f) side or perspective views of the drill bit bodies and/or anvil portions.

### SPECIFIC DESCRIPTION

An embodiment of a percussion drill bit assembly described with reference to FIG. 1 comprises a percussion drill it head, 100, comprising a working portion, 110, and buttons, 120, protruding from a working surface, 130, and a hard area, 135, which is free of buttons and has Rockwell C hardness of at least 60 HRc. The drill bit head, 100, further comprises a stem or shank portion, 140, for removably mounting the drill bit head, 100 to an anvil part, 200, of a drill bit assembly, the anvil having a recess adapted to receive and hold securely at least the stem or shank portion, 140, of the drill bit head, 100.

In a preferred version of the embodiment, substantially the entire volume of at least the working portion, 110, comprises a hard-metal, such as cemented tungsten carbide.

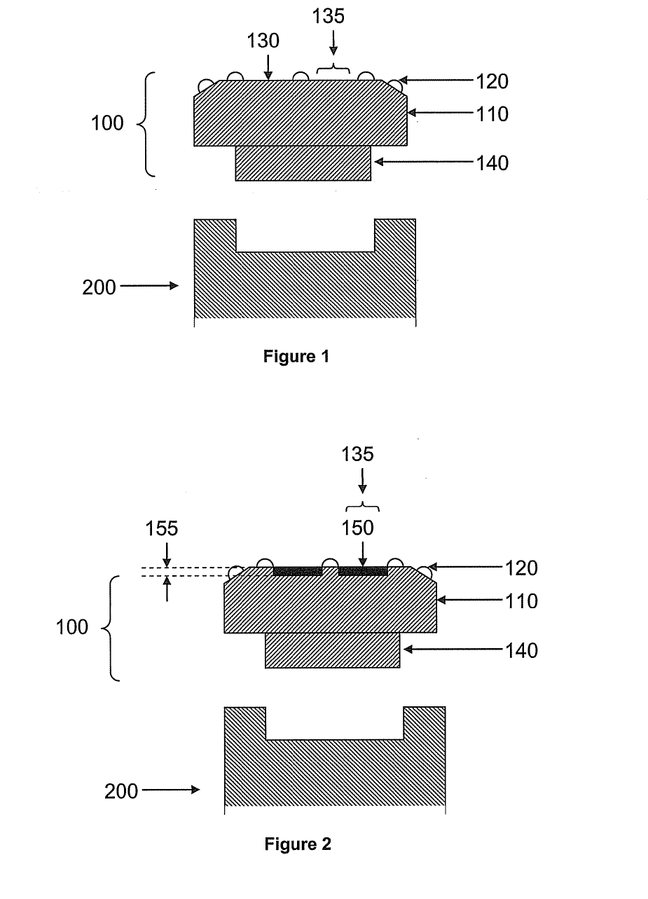

An embodiment of a percussion drill bit assembly described with reference to FIG. 2 comprises a percussion drill bit head, 100, comprising a working portion, 110, and buttons, 120, protruding from a working surface, 130, a hard area, 135, which is free of buttons and has Rockwell C hardness of at least 60 HRc, and a hard volume, 150, coterminous with the hard area, 135, the hard volume extending from the working surface to a depth, 155, the hard volume consisting of hard material having Rockwell C hardness greater than 60 HRc. The drill bit head, 100, further comprises a stem or shank portion, 140, for removably mounting the drill bit head to an anvil part, 200, of a drill bit assembly, the anvil, 200, having a recess adapted to receive and hold securely the drill bit head.

In a preferred embodiment, substantially the entire volume of at least the working portion, 110, comprises a type of steel and substantially the entire hard volume comprises a hard-metal, such as cemented tungsten carbide.

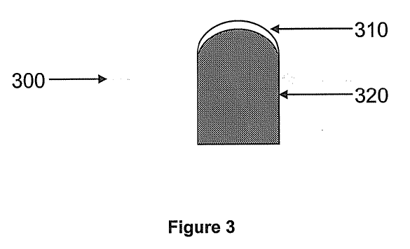

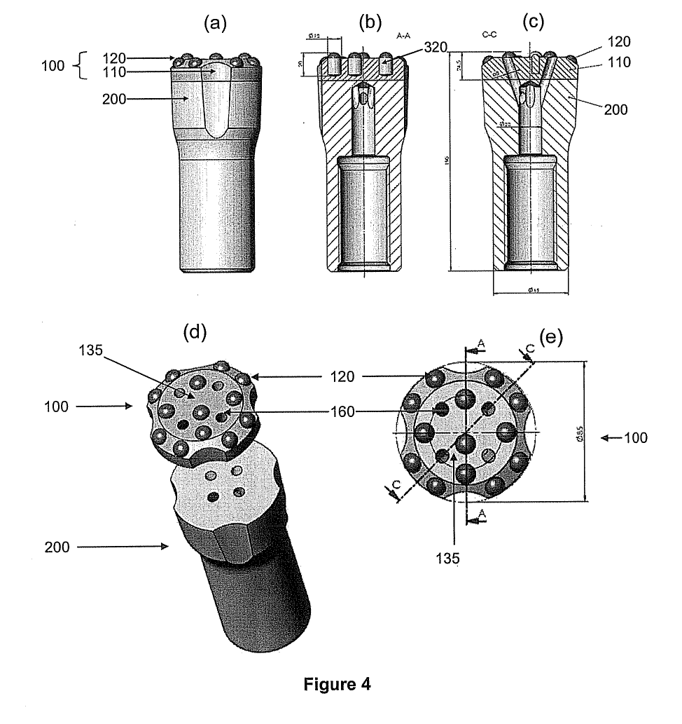

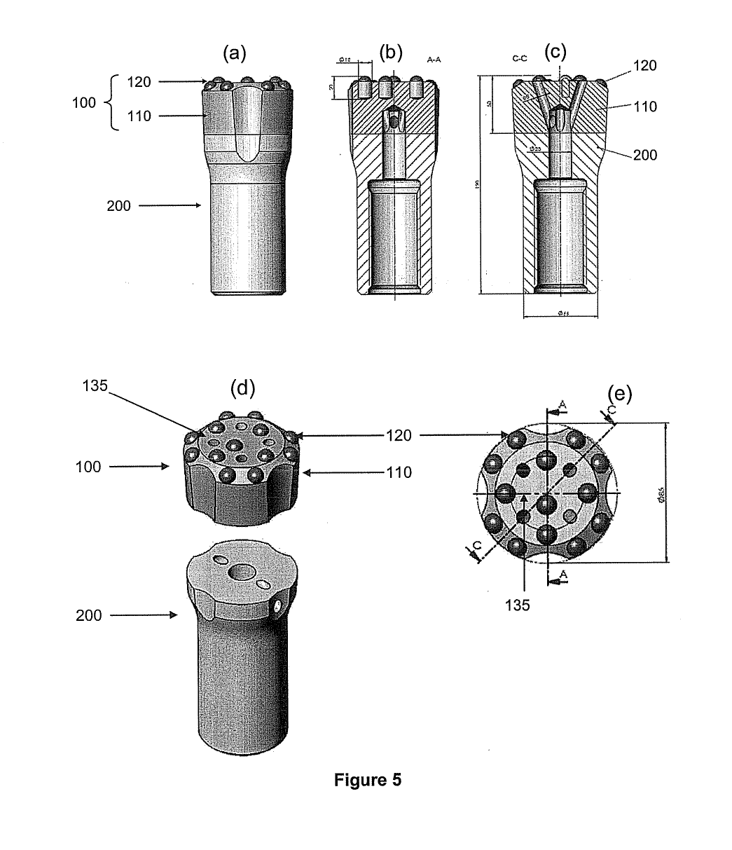

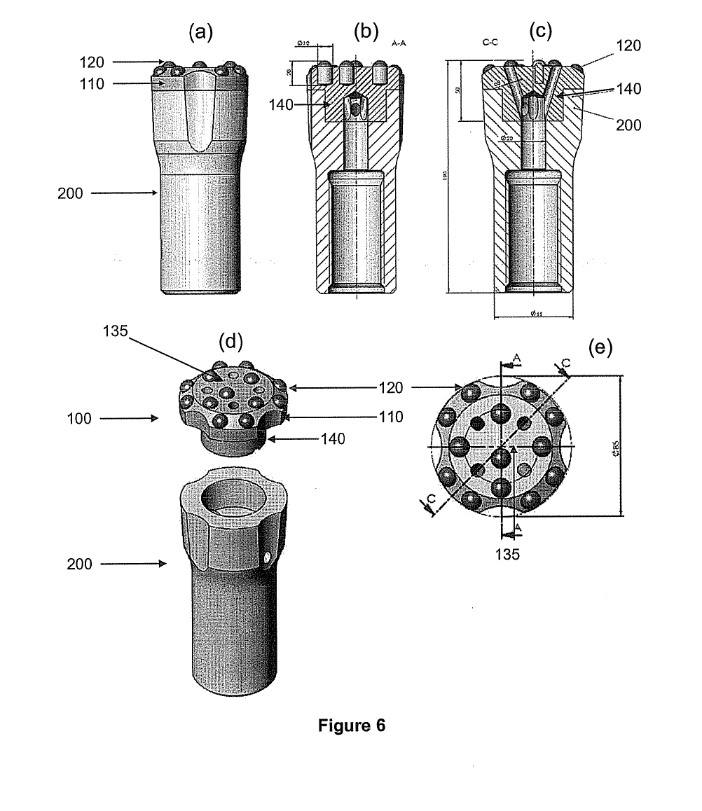

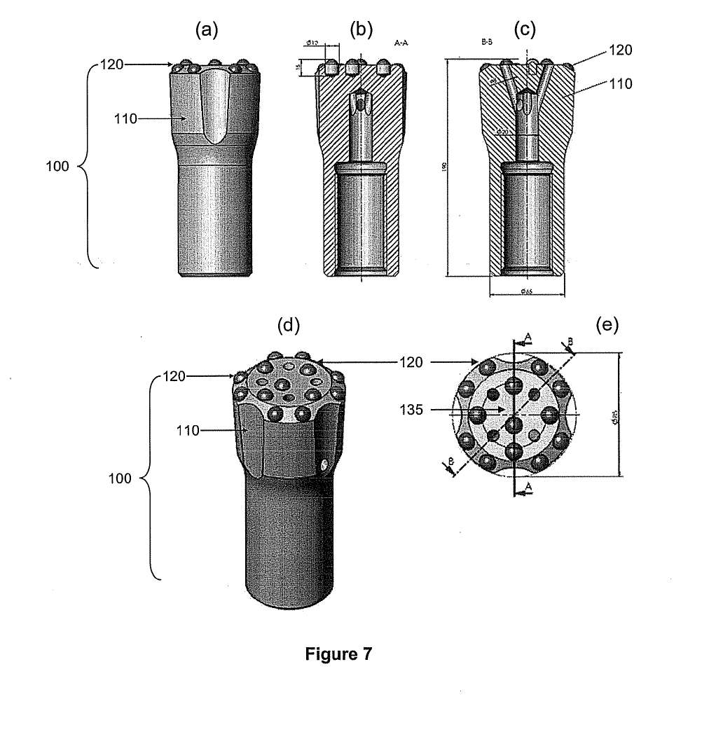

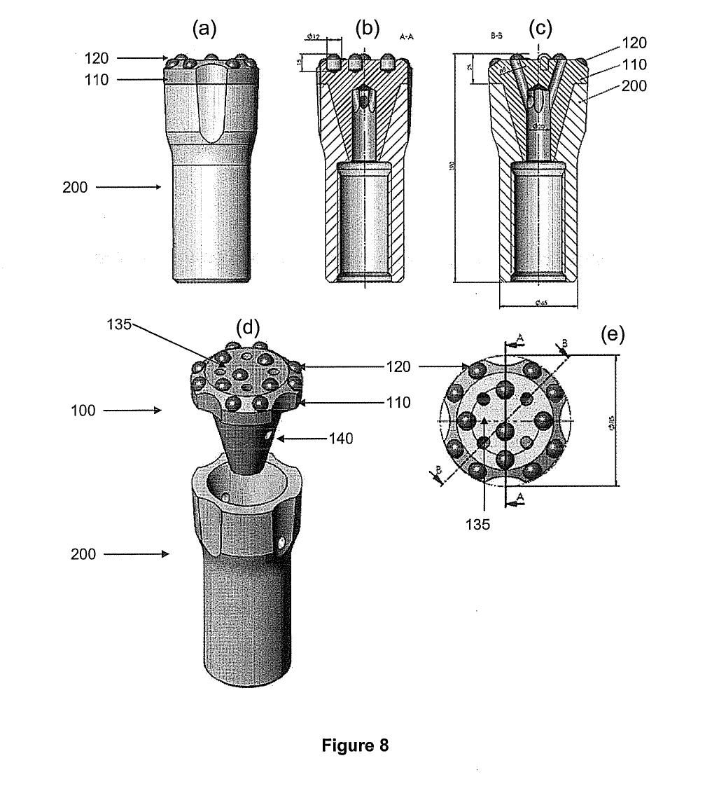

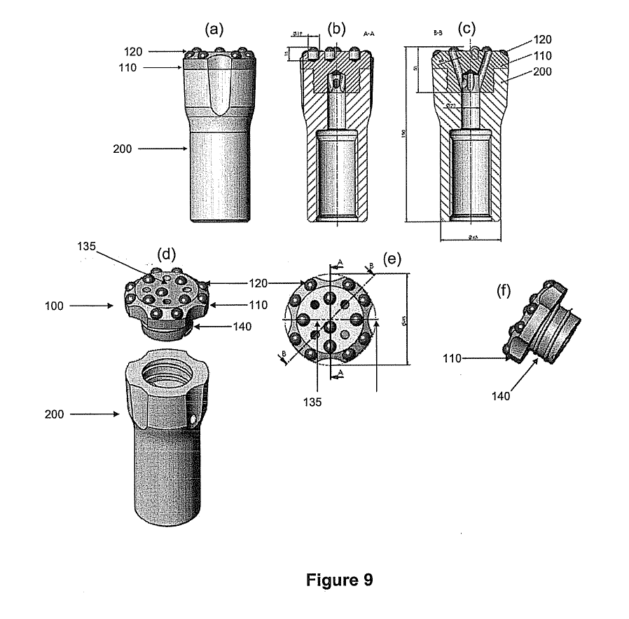

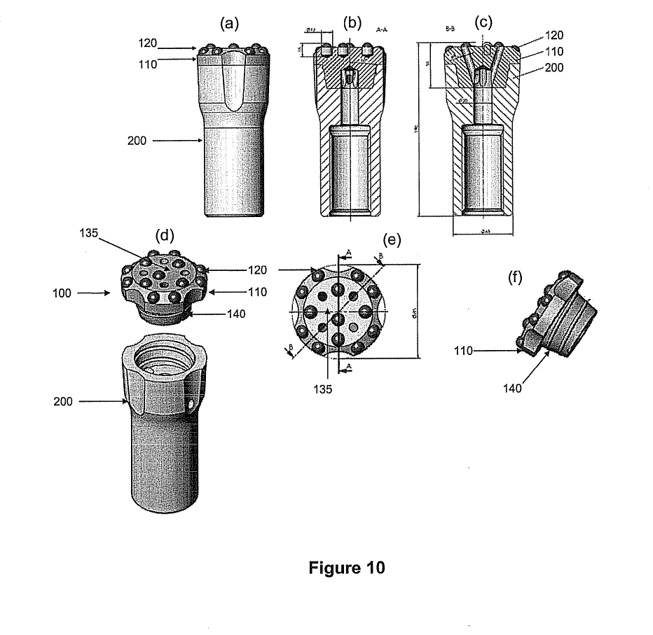

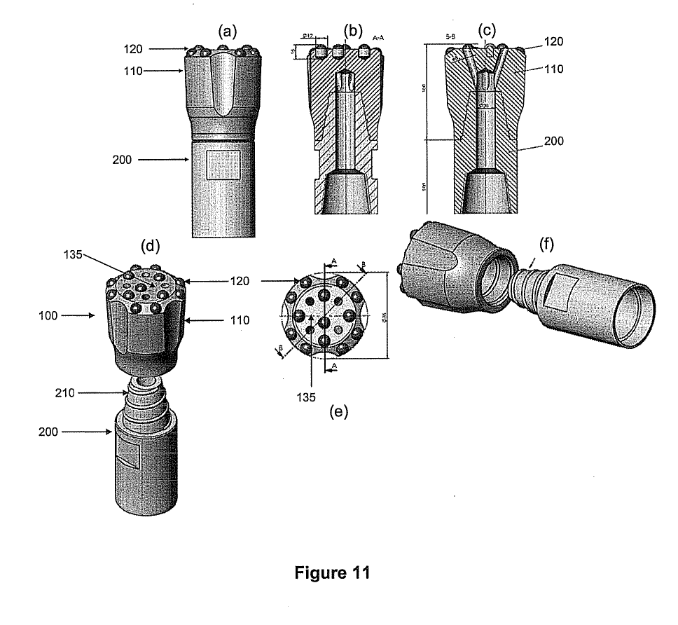

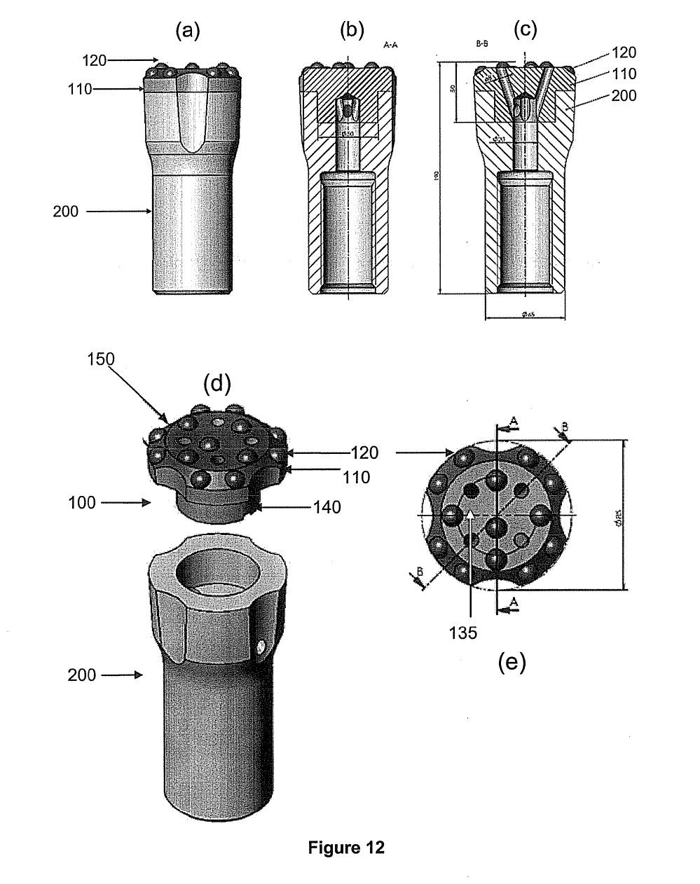

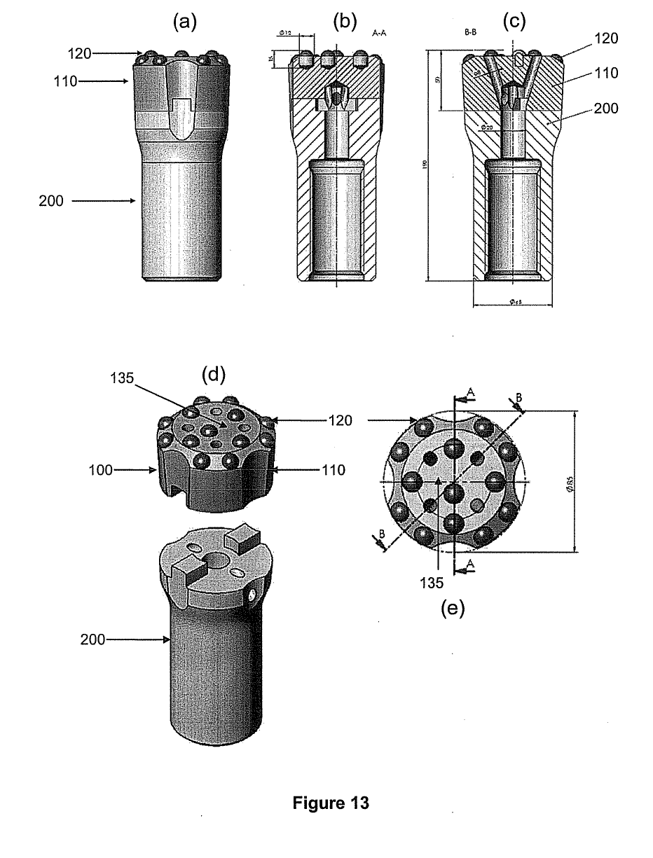

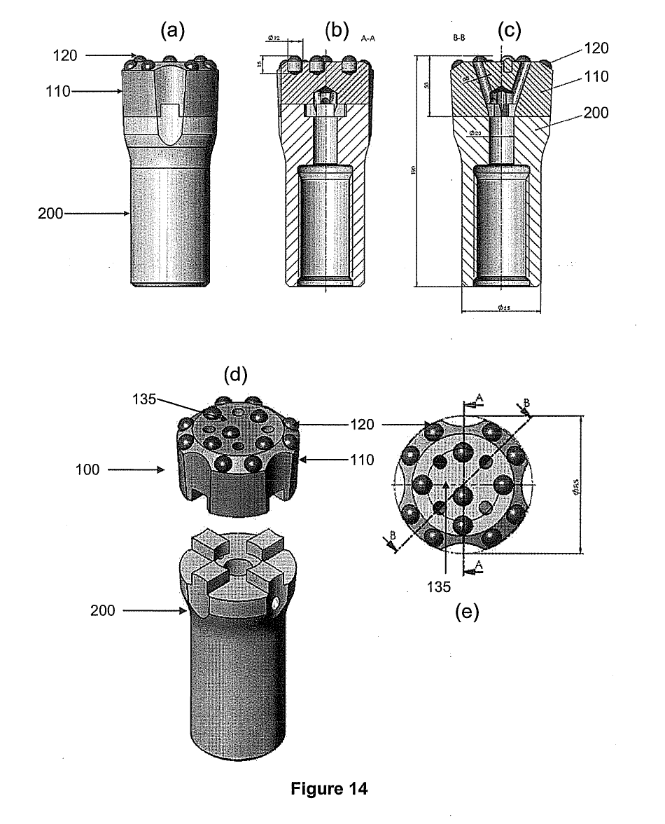

An embodiment of a button that is in the form of a domed insert, 300, described with reference to FIG. 3, comprises a layer, 310, of super-hard material integrally bonded to a hard-metal support substrate, 320. In a preferred embodiment, the super-hard material is polycrystalline diamond and the hard-metal is cemented tungsten carbide. In use, a portion of the support substrate is embedded into recesses within a drill bit head, the recesses (not shown) adapted to receive and hold securely the inserts.

An embodiment of a percussion drill bit assembly described with reference to FIG. 4 comprises a drill bit head, 100, comprising a cemented carbide drill bit head body, 110, to which have been affixed a plurality of inserts (buttons), 120, and a steel anvil portion, 200, of a drill bit. Each insert comprises a layer of polycrystalline diamond integrally bonded to a cemented tungsten carbide support substrate, which is embedded into the drill bit head body, 110, with the polycrystalline diamond layer protruding from a working surface of the drill bit head body, 110, which comprises a plurality of recesses adapted to accommodate and securely hold the plurality of inserts, 120. The working surface has at least one hard area, 135, free of inserts. The drill bit head body, 110, comprises at least one through-hole, 160, to conduct a fluid which may be introduced to flush out debris. The drill bit head, 100, is mounted or mountable onto an anvil portion, 200, of a drill bit assembly (not shown).

An embodiment of a percussion drill bit assembly described with reference to FIG. 5 has similar features to those described with reference to FIG. 4, except that the drill bit head body, 110, has a substantially larger volume and a side surface with substantially greater surface area than the corresponding side surface of FIG. 4.

An embodiment of a percussion drill bit assembly described with reference to FIG. 6 has similar features to those described with reference to FIG. 4, except that the drill bit head, 100, comprises in addition to a bit head body, 110, a generally cylindrical stem or shank, 140, depending therefrom. The stem is press-fittable into a corresponding recess within the anvil portion, 200, the recess being adapted to accommodate and hold securely at least the stem of shank, 140, of the bit head.

An embodiment of a percussion drill bit, 100, described with reference to FIG. 7 comprising a cemented carbide bit head body, 110, to which have been affixed a plurality of inserts (buttons), 120; and a steel anvil portion of a drill bit. Each insert, 120, comprises a layer of polycrystalline diamond integrally bonded to a cemented tungsten carbide support substrate, which is embedded into the bit head body, 110, with the polycrystalline diamond layer protruding from a working surface of the bit head body, 110, which comprises a plurality of recesses adapted to accommodate and securely hold the plurality of inserts, 120. The working surface has at least one hard area, 135, free of inserts. The bit head body, 110, comprises at least one through-hole, 160, to conduct a fluid which may be introduced to flush out debris.

An embodiment of a percussion drill bit assembly described with reference to FIG. 8 has similar features to those described with reference to FIG. 4, except that the drill bit head, 100, comprises in addition to a bit head body, 110, a generally frustoconical or tapered stem, 140, depending therefrom. The stem is press-fittable into a corresponding recess within the anvil portion, 200, the recess being adapted to accommodate and hold securely at least the stem or shank, 140, of the bit head, 100.

An embodiment of a percussion drill bit assembly described with reference to FIG. 9 has similar features to those described with reference to FIG. 4, except that the generally cylindrical stem, 140, has a threading and is capable of being screwed into a correspondingly threaded recess within the anvil portion, 200, the recess being adapted to accommodate and hold securely at least the stem or shank, 140, of the bit head, 100.

An embodiment of a percussion drill bit assembly described with reference to FIG. 10 has similar features to those described with reference to FIG. 4, except that the cylindrical stem, 140, has a generally frustoconical or tapered form and has a threading and is capable of being screwed into a correspondingly threaded recess within the anvil portion, 200, the recess being adapted to accommodate and hold securely at least the stem or shank, 140, of the bit head, 100.

An embodiment of a percussion drill bit assembly described with reference to FIG. 11 comprises a drill bit head, 100, comprising a cemented carbide bit head body, 110, to which have been affixed a plurality of inserts, 120, and a steel anvil portion, 200, of a drill bit. The bit head is mounted or mountable onto an anvil portion, 200, of a drill bit assembly. The anvil portion, 200, comprises a generally frustoconical or tapered end, 210, which is threaded and the bid head body, 110, is correspondingly adapted with a recess to accommodate the anvil end, 210, which may be screwed into the recess.

An embodiment of a percussion drill bit assembly described with reference to FIG. 12 comprises a drill bit head, 100, comprising a bit head body, 110, to which have been affixed a plurality of inserts, 120, and a steel anvil portion, 200, of a drill bit. A layer, 150, of cemented tungsten carbide has been deposited onto a working surface of the bit head, 100, defining a hard area, which is free of inserts.

Embodiments of percussion drill bit assemblies described with reference to FIGS. 13 and 14 comprise bit head bodies, 110, having slots for accommodating cooperating tongues projecting from the anvil, 200. It will be appreciated that the anvil, 200, may have the slots and the bit head body, 110, the cooperating tongues, or both anvil and bit head may have combinations of cooperating slots and tongues. The use of slots and tongues has the advantage that support is provided against tortional or radial forces that may act on the drill bit head in use.

In one embodiment, the wear-resistant bit head comprises a hard material throughout substantially all of its volume. In an alternative embodiment, the bit head comprises more than one material with different hardnesses, and is adapted so that a material at the attachment interface may be more readily attached to the bit body support by brazing or other metallurgical or chemical means. For example, if the bit body support comprises steel at the attachment interface, it may be desirable that the bit head also comprises steel at that interface in order to facilitate joining the two components or to reduce costs.

1. A percussion drill bit head for a percussion drilling apparatus, the drill bit head comprising a working surface and a plurality of super-hard buttons protruding from the working surface, the working surface having a hard area that is free of buttons and has Rockwell C hardness of at least 60 HRc.

2. A drill bit head according to claim 1, wherein at least 50% of the plurality of buttons comprises a super-hard material.

3. A drill bit head according to claim 1, wherein the hard area comprises a hard-metal.

4. A drill bit head according to claim 1, wherein at least 10% of the volume of the drill bit head consists of hard material having Rockwell C hardness greater than 60 HRc.

5. A drill bit head according to claim 1, wherein the drill bit head comprises a hard volume coterminous with the hard area, the hard volume extending from the working surface to a depth, the hard volume consisting of hard material having Rockwell C hardness greater than 60 HRc, the depth being at least 0.5 millimetres.

6. A drill bit head according to claim 1, wherein the hard area covers at least 20% of the maximum working surface.

7. A drill bit head according to claim 1, wherein the buttons are inserts comprising diamond.

8. A drill bit head according to claim 1, wherein the drill bit head is removably attachable to an anvil assembly by mechanical, chemical or metallurgical methods, or by a combination of any of these methods.

9. A method of manufacturing a percussion drill bit head according to claim 1, the method including subjecting the percussion drill bit head or precursor thereof or portion thereof including a region of the working surface that is free of buttons to a pressure of at least 20 MPa and a temperature of at least 900 degrees centigrade.

10. A method according to claim 9, wherein the drill bit head is produced by sintering a green body by means of a conventional hard-metal sintering method.

11. A method according to claim 9, wherein the drill bit head is manufactured by a process including subjecting a green body to a sintering step wherein the pressure is at least 20 MPa and a temperature of at least 900 degrees centigrade to form a sintered bit body, and affixing a plurality of buttons to the sintered bit body.

12. A method according to claim 11, wherein the buttons are inserts comprising polycrystalline diamond integrally bonded to a hard-metal support substrate.

13. A method for manufacturing a percussion drill bit head according to claim 1, the method including forming a drill bit head or portion thereof and depositing a layer of hard material onto a working surface of the drill bit head or portion thereof, the layer of hard material having Rockwell C hardness greater than 60 HRc.

14. A method according to claim 13 wherein the layer of hard material is deposited by means of thermal spraying, by a welding method, or by a brazing method.

15. A percussion drill bit assembly comprising a percussion drill bit head according to claim 1.

16. A percussion drill bit assembly manufactured by a method according to claim 9.
